(19) United States
(12) Patent Application Publication
(10) Pub. No.: US 2026/0117930 A1
(43) Pub. Date: Apr. 30, 2026

(54) BOIL-OFF FUEL USAGE

(71) Applicant: Honda Motor Co., Ltd., Tokyo (JP)

(72) Inventor: David PERZYNSKI, Signal Hill, CA (US)

(21) Appl. No.: 18/926,205

(22) Filed: Oct. 24, 2024

(51) Int. Cl. F17C 9/04; H01M 8/04082; H01M 8/04089; H01M 8/0432; H01M 8/0438

(52) U.S. Cl. CPC F17C 9/04; H01M 8/04089; H01M 8/04208; H01M 8/04365; H01M 8/04425; F17C 2221/012; F17C 2223/0161

(57) ABSTRACT

According to one aspect, boil-off fuel usage may include receiving a characteristic of a gas stored in a tank, determining whether the gas stored in the tank is at boil-off based on the characteristic of the gas, controlling a valve between the tank and a generator to open based on the gas being at boil-off, generating energy using the gas when the valve may be open, and storing the energy generated by the generator in an energy storage device.

### BACKGROUND

The space-saving benefits of storing gas in liquid form were recognized a while ago, but a practical, commercially viable solution for storing liquid gases did not come about until around 1898. One of the problems recognized early on with the storage of gases as liquids at cryogenic temperatures (e.g., typically ˜150 degrees C) is boil-off gas (BOG). This occurs when heat from a variety of sources transfers into the tank causing the liquid to boil and the pressure in the tank to rise.

A number of conditions can lead to boil-off gas within a cryogenic vessel, such as heat being absorbed from ambient air by refrigerated storage tanks, heat absorbed from ambient air bylines, heat produced by the operation of pumps, vapor displacement due to a liquid inlet in the tank, or a rapid variation of barometric pressure.

### BRIEF DESCRIPTION

According to one aspect, a system for boil-off fuel usage may include a communication interface, a processor, a memory, a generator, and an energy storage device. The communication interface may receive a characteristic of a gas stored in a tank. The memory may store one or more instructions. The processor may execute one or more of the instructions stored on the memory to perform one or more acts, actions, and/or steps. For example, the processor may determine whether the gas stored in the tank is at boil-off based on the characteristic of the gas and control a valve between the tank and a generator to open based on the gas being at boil-off. The generator may generate energy using the gas when the valve is open. The energy storage device may store the energy generated by the generator.

The characteristic of the tank may be a temperature, a pressure, a flow rate, or a mass. The gas may be hydrogen gas. The energy storage device may include a fuel cell or a battery. The determining whether the gas stored in the tank is at boil-off may be based on a temperature of the gas. The system for boil-off fuel usage may include a sensor detecting the characteristic of the gas stored in the tank. The sensor may be mounted to the tank. The processor may control the valve between the tank and the generator to close based on the characteristic of the gas. The processor may control the valve between the tank and the generator to close based on the gas not being at boil-off. The processor may control the valve between the tank and the generator to close based on the temperature of the gas.

According to one aspect, a computer-implemented method for boil-off fuel usage may include receiving a characteristic of a gas stored in a tank, determining whether the gas stored in the tank is at boil-off based on the characteristic of the gas, controlling a valve between the tank and a generator to open based on the gas being at boil-off, generating energy using the gas when the valve may be open, and storing the energy generated by the generator in an energy storage device.

According to one aspect, a system for boil-off fuel usage may include a communication interface, a processor, a memory, a generator, and an energy storage device. The communication interface may receive a characteristic of a gas stored in a tank. The memory may store one or more instructions. The processor may execute one or more of the instructions stored on the memory to perform one or more acts, actions, and/or steps. For example, the processor may predict when the gas stored in the tank is near boil-off based on the characteristic of the gas and control a valve between the tank and a generator to open based on the prediction. The generator may generate energy using the gas when the valve is open. The energy storage device may store the energy generated by the generator.

### BRIEF DESCRIPTION OF THE DRAWINGS

FIGS. 1-2 are exemplary component diagrams of a system for boil-off fuel usage, according to one aspect.

FIG. 3 is an exemplary flow diagram of a computer-implemented method for boil-off fuel usage, according to one aspect.

FIG. 4 is an illustration of an example computing environment where one or more of the provisions set forth herein are implemented, according to one aspect.

FIG. 5 is an illustration of an example computer-readable medium or computer-readable device including processor-executable instructions configured to embody one or more of the provisions set forth herein, according to one aspect.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein, may be combined, omitted, or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

A “database”, as used herein, may refer to a table, a set of tables, and a set of data stores (e.g., disks) and/or methods for accessing and/or manipulating those data stores.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “mobile device”, as used herein, may be a computing device typically having a display screen with a user input (e.g., touch, keyboard) and a processor for computing. Mobile devices include handheld devices, portable electronic devices, smart phones, laptops, tablets, and e-readers.

This disclosure relates to boil-off fuel usage. Rather than trying to capture boil-off for LH2, the system may consume any “pre-boil-off” fuel or gas continuously into an energy storage device, such as a fuel cell. This “pre-boil-off” fuel or gas may then be converted into power. Through continuously consuming the hydrogen to mitigate boil-off, the pressure of the tank may remain low enough that actual boil-off is unnecessary. This is advantageous or beneficial for the technical field of fuel tanks and fuel cells because the boiled-off gas is not being wasted, and is instead consumed and utilized to generate power or energy.

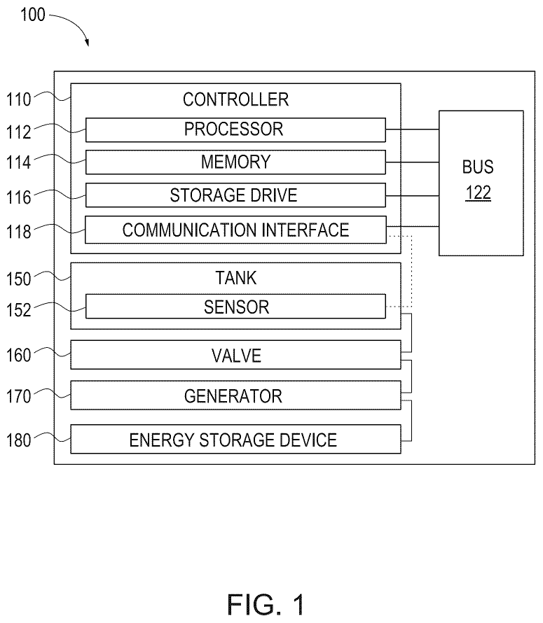

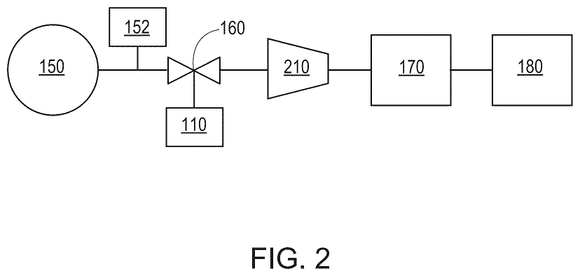

FIGS. 1-2 are exemplary component diagrams of a system for boil-off fuel usage, according to one aspect. The system for boil-off fuel usage may include a controller 110. The controller 110 may include a processor 112, a memory 114, a storage drive 116, and a communication interface 118 operably connected by a bus 122. The system for boil-off fuel usage may include a tank 150, a sensor 152 mounted to the tank 150, a valve 160 (e.g., including an actuator), a generator 170, and an energy storage device 180 (e.g., a battery or a fuel cell).

The sensor 152 may detect a characteristic of a gas (e.g., hydrogen gas) stored in the tank 150 and transmit the characteristic to the communication interface 118. The sensor 152 may be mounted to the tank 150 and the characteristic of the tank 150 may be a temperature, a pressure, a flow rate, or a mass. The communication interface 118 may receive the characteristic of the gas stored in the tank 150. The memory 114 may store one or more instructions. The processor 112 may execute one or more of the instructions stored on the memory 114 to perform one or more acts, actions, and/or steps.

Hydrogen may be stored physically as either a gas or a liquid. Storage of hydrogen as a gas typically involves high-pressure tanks (e.g., 350-700 bar or 5000-10,000 psi tank pressure). Storage of hydrogen as a liquid may require cryogenic temperatures because the boiling point of hydrogen at one atmosphere pressure is −252.8°C.

For example, the processor 112 may determine whether the gas stored in the tank 150 is at boil-off based on the characteristic of the gas and the Antoine Equation or predict when the gas stored in the tank 150 is near boil-off based on the characteristic of the gas and the Antoine Equation. The processor 112 may control a valve 160 (e.g., including an actuator) between the tank 150 and a generator 170 to open based on the gas being at boil-off or the prediction that the gas is within a threshold (e.g., temperature, pressure, flow rate, etc.) of boiling off. According to one aspect, the processor 112 may generate the prediction based on a trend in the characteristic over time, as sensed by the sensor 152. The determining whether the gas stored in the tank 150 is at boil-off may be based on a temperature, a pressure, a flow rate, a volume, etc. of the gas.

The processor 112 may control the valve 160 between the tank 150 and the generator 170 to close based on the characteristic of the gas. For example, the processor 112 may control the valve 160 between the tank 150 and the generator 170 to close based on the gas not being at boil-off or based on the temperature, the pressure, the flow rate, or the volume of the gas and based on the Antoine Equation. According to one aspect, a compressor 210 may be disposed between the valve 160 and the generator 170.

The generator 170 may generate energy using the gas when the valve 160 is open. The generator 170 may include a fuel container, a spent fuel container, a catalyst system and a control system for generating hydrogen from a reaction, such as a reaction including a hydride solution. The energy storage device 180 may store the energy generated by the generator 170. The energy storage device 180 may include a fuel cell or a battery.

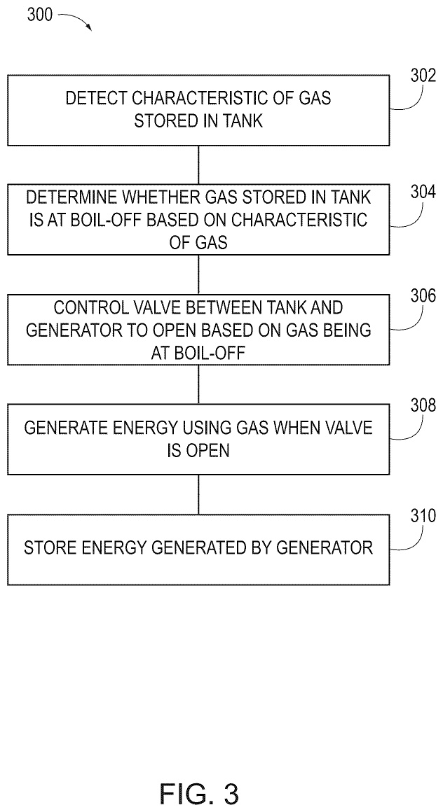

FIG. 3 is an exemplary flow diagram of a computer-implemented method 300 for boil-off fuel usage, according to one aspect. The computer-implemented method 300 for boil-off fuel usage may include receiving 302 a characteristic of a gas stored in a tank, determining 304 whether the gas stored in the tank is at boil-off based on the characteristic of the gas, controlling 306 a valve between the tank and a generator to open based on the gas being at boil-off, generating 308 energy using the gas when the valve may be open, and storing 310 the energy generated by the generator in an energy storage device.

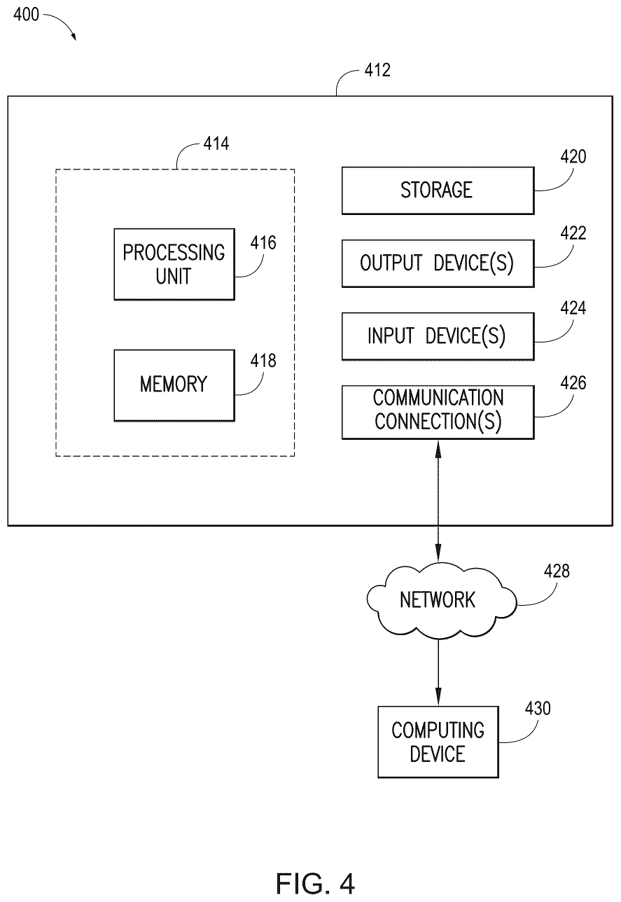

FIG. 4 and the following discussion provide a description of a suitable computing environment to implement aspects of one or more of the provisions set forth herein. The operating environment of FIG. 4 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 4 illustrates a system 400 including a computing device 412 configured to implement one aspect provided herein. In one configuration, the computing device 412 includes at least one processing unit 416 and memory 418. Depending on the exact configuration and type of computing device, memory 418 may be volatile, such as RAM, non-volatile, such as ROM, flash memory, etc., or a combination of the two. This configuration is illustrated in FIG. 4 by dashed line 414.

In other aspects, the computing device 412 includes additional features or functionality. For example, the computing device 412 may include additional storage such as removable storage or non-removable storage, including, but not limited to, magnetic storage, optical storage, etc. Such additional storage is illustrated in FIG. 4 by storage 420. In one aspect, computer readable instructions to implement one aspect provided herein are in storage 420. Storage 420 may store other computer readable instructions to implement an operating system, an application program, etc. Computer readable instructions may be loaded in memory 418 for execution by the at least one processing unit 416, for example.

The term “computer readable media” as used herein includes computer storage media. Computer storage media includes volatile and nonvolatile, removable, and non-removable media implemented in any method or technology for storage of information such as computer readable instructions or other data. Memory 418 and storage 420 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 412. Any such computer storage media is part of the computing device 412.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 412 includes input device(s) 424 such as keyboard, mouse, pen, voice input device, touch input device, infrared cameras, video input devices, or any other input device. Output device(s) 422 such as one or more displays, speakers, printers, or any other output device may be included with the computing device 412. Input device(s) 424 and output device(s) 422 may be connected to the computing device 412 via a wired connection, wireless connection, or any combination thereof. In one aspect, an input device or an output device from another computing device may be used as input device(s) 424 or output device(s) 422 for the computing device 412. The computing device 412 may include communication connection(s) 426 to facilitate communications with one or more other devices 430, such as through network 428, for example.

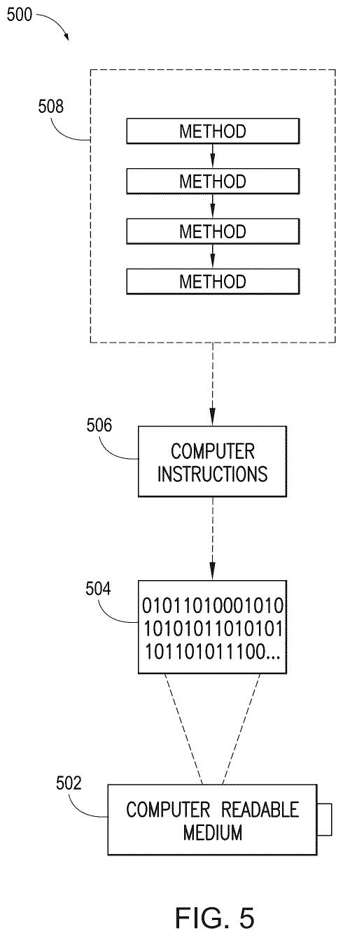

Still another aspect involves a computer-readable medium including processor-executable instructions configured to implement one aspect of the techniques presented herein. An aspect of a computer-readable medium or a computer-readable device devised in these ways is illustrated in FIG. 5, wherein an implementation 500 includes a computer-readable medium 502, such as a CD-R, DVD-R, flash drive, a platter of a hard disk drive, etc., on which is encoded computer-readable data 504. This encoded computer-readable data 504, such as binary data including a plurality of zero's and one's as shown in 504, in turn includes a set of processor-executable computer instructions 506 configured to operate according to one or more of the principles set forth herein. In this implementation 500, the processor-executable computer instructions 506 may be configured to perform a method 508, such as the computer-implemented method 300 of FIG. 3. In another aspect, the processor-executable computer instructions 506 may be configured to implement a system, such as the system 100 for boil-off fuel usage of FIGS. 1-2. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. A system for boil-off fuel usage, comprising:
a communication interface receiving a characteristic of a gas stored in a tank;
a memory storing one or more instructions;
a processor executing one or more of the instructions stored on the memory to perform:
determining whether the gas stored in the tank is at boil-off based on the characteristic of the gas; and
controlling a valve between the tank and a generator to open based on the gas being at boil-off;
the generator generating energy using the gas when the valve is open; and
an energy storage device storing the energy generated by the generator.

2. The system for boil-off fuel usage of claim 1, wherein the characteristic of the tank is a temperature, a pressure, a flow rate, or a mass.

3. The system for boil-off fuel usage of claim 1, wherein the gas is hydrogen gas.

4. The system for boil-off fuel usage of claim 1, wherein the energy storage device includes a fuel cell or a battery.

5. The system for boil-off fuel usage of claim 1, wherein the determining whether the gas stored in the tank is at boil-off is based on a temperature of the gas.

6. The system for boil-off fuel usage of claim 1, comprising a sensor detecting the characteristic of the gas stored in the tank.

7. The system for boil-off fuel usage of claim 6, wherein the sensor is mounted to the tank.

8. The system for boil-off fuel usage of claim 1, wherein the processor controls the valve between the tank and the generator to close based on the characteristic of the gas.

9. The system for boil-off fuel usage of claim 1, wherein the processor controls the valve between the tank and the generator to close based on the gas not being at boil-off.

10. The system for boil-off fuel usage of claim 1, wherein the processor controls the valve between the tank and the generator to close based on a temperature of the gas.

11. A computer-implemented method for boil-off fuel usage, comprising:
receiving a characteristic of a gas stored in a tank;
determining whether the gas stored in the tank is at boil-off based on the characteristic of the gas;
controlling a valve between the tank and a generator to open based on the gas being at boil-off;
generating energy using the gas when the valve is open; and
storing the energy generated by the generator in an energy storage device.

12. The computer-implemented method for boil-off fuel usage of claim 11, wherein the characteristic of the tank is a temperature, a pressure, a flow rate, or a mass.

13. The computer-implemented method for boil-off fuel usage of claim 11, wherein the gas is hydrogen gas.

14. The computer-implemented method for boil-off fuel usage of claim 11, wherein the energy storage device includes a fuel cell or a battery.

15. The computer-implemented method for boil-off fuel usage of claim 11, wherein the determining whether the gas stored in the tank is at boil-off is based on a temperature of the gas.

16. A system for boil-off fuel usage, comprising:
a communication interface receiving a characteristic of a gas stored in a tank;
a memory storing one or more instructions;
a processor executing one or more of the instructions stored on the memory to perform:
predicting when the gas stored in the tank is near boil-off based on the characteristic of the gas; and
controlling a valve between the tank and a generator to open based on the prediction;
the generator generating energy using the gas when the valve is open; and
an energy storage device storing the energy generated by the generator.

17. The system for boil-off fuel usage of claim 16, wherein the characteristic of the tank is a temperature, a pressure, a flow rate, or a mass.

18. The system for boil-off fuel usage of claim 16, wherein the gas is hydrogen gas.

19. The system for boil-off fuel usage of claim 16, wherein the energy storage device includes a fuel cell or a battery.

20. The system for boil-off fuel usage of claim 16, wherein the predicting whether the gas stored in the tank is at boil-off is based on a temperature of the gas.
